(19) United States
(12) Patent Application Publication
(10) Pub. No.: US 2004/0020336 A1
(43) Pub. Date: Feb. 5, 2004

(54) Tool for quick removal and installation of drain

(76) Inventors: Thomas Farrell, Torrance, CA (US); Clarence Watson, Torrance, CA (US)

Correspondence Address: JOHN E. HALAMKA, P.O. BOX 207, PALOS VERDES EST, CA, 90274, US

(21) Appl. No.: 10/602,058

(22) Filed: Jun. 23, 2003

Related U.S. Application Data
(60) Provisional application No. 60/390,548, filed on Jun. 24, 2002.

(51) Int. Cl. B25B 23/00

(52) U.S. Cl. 81/461

(57) ABSTRACT

A tool arrangement combination of an insert tool fabricated as a generally circular central body having a plurality of spokes extending from the outside peripheral edge of said central body, said spokes spaced apart to be mountable into the channels formed on the inside peripheral surface of the internal nut of a standard drain fixture. Said central body having a non-circular opening configuration to accept the insertion of a user-supplied lever, usually a common tool such as a socket wrench handle to complete the tool arrangement. The tool arrangement may be used to evenly apply torque to say internal nut to remove or tighten said internal nut of said drain fixture.

### BACKGROUND OF THE INVENTION

1. Field of the Invention

This invention relates to the art of removably attaching at least the retaining ring for a drain fixture and more particularly providing quick on and off attachment of the retaining ring for an instant set shower drain by means of a tool arrangement that is configured to provide a mechanical advantage to allow the removal of the interior nut threaded onto a mating thread on the drain fixture fitted to the opening of a shower pan leading to the drain pipe. With the mechanical advantage the tool arrangement, the retaining ring may be removed even if the peripheral edge of the drain fixture has been sealed or the retaining ring has been in placed for a number of years. This application is based upon the Provisional Patent filed Jun. 24, 2002 as Serial No. 60/390,548.

2. Description of the Prior Art

The art of installing and removing retaining rings has a long history and many variations. Sealing of a drainpipe to the opening in a shower pan to allow the draining of water without leakage around the perimeter of the drainpipe is critical. If the seal is not water tight, some additional calking or sealing may be necessary to prevent water damage. Settling of the supports for the drainpipe or shifting of the alignment of the drainpipe especially if a building is subjected to severe weather or earthquake may cause connections to leak and require corrective maintenance of the connection. The teaching herein is of a tool arrangement removably inserted inside the retaining ring, said tool arrangement providing a mechanical advantage to evenly apply torque to the retaining ring and may also be used for the insertable removal and sealing of other drain hole openings to drain pipes for other than shower pan devices such as sinks.

Disengagement and reengagement of the retaining ring is the initial step required to install and maintain the drain fixture and establish waterproof drain function. A plurality of channels are formed in the internal perimeter of the retaining ring to allow turning of the retaining ring for removal or installation. Some drain fixture manufacturers utilize only two channels; others utilize four, eight or sixteen.

Currently there are many different configurations of a drain hole in a shower pan or sink that requires connection to a drainpipe. A generally standard drain fixture provides an interface between the drain hole and the drainpipe.

A drain fixture is generally a combination of elements configured to provide a peripherally sealed mounting of the drain fixture in the drain hole of the shower of sink on one end and an internally sealed connection to a drainpipe on the other end to provide for egress of drain water without leakage.

Each time the user wishes to remove or perform maintenance on the connection between the drain hole and the drainpipe as well as upon initial installation, the retaining ring must be removed and then reinstalled. If the prior installation was not sealed properly, the leak may be corrected by additional sealant or external calking or if the retaining ring has been in place for some extended time the retaining ring may simply develop corrosion of the threads on the retaining ring and may contribute to difficulty in removal of the retaining ring.

The current art teaches the use of a drain fixture manufacture's supplied tool to span the drain opening by insertion of the tips of a manufacturer's supplied tool into opposing channels around the inside perimeter of the retaining ring. The tool is fabricated with a central slot into which another tool such as a screwdriver may be inserted. A screwdriver does not provide a large mechanical advantage to create torque to be applied through the manufacturer's tool tips to the retaining ring. As the manufacturer's tool has no restraining mechanism between it and the tool inserted therein, the manufacturer's tool may become dislodged from the channels in the retaining ring and simply fall into the drain. When the drainpipe is deep, it is sometimes difficult to locate and retrieve the manufacture's tool.

Further, the manufacture's tool is provided as a throw away piece and is usually stamped out of thin sheet stock that is incapable of sustaining the large torque force sometimes required to overcome the seal between the retaining ring and the drain pipe fixture. The tool becomes deformed and useless. Additional work and sometimes-destructive removal of the retaining ring may become necessary. Should the destructive removal of the retaining ring encompass the drain pipe fixture thread or involve the enlargement of the hole in the pan, further maintenance with adaptors, sealing, replacement of fixtures may be necessary to complete the installation or maintenance procedure all to the determent of the user.

Direct, evenly distributed torque pressure is most effective to force the retaining ring to unscrew from the drain pipe fixture threads and screw back on to establish the seal between the drain pipe fixture and the drainpipe.

Thus, there has long been a need for a tool arrangement that allows the user to easily engage and disengage the internal channels of a retaining ring and thereafter apply sufficient torque to overcome a prior sealing of the retaining ring to the drain fixture or apply sufficient force to tighten the retaining ring into the drain fixture to seal the connection with the drainpipe.

It is desired that the tool arrangement allow easy generation of sufficient torque and adjustment of the seal to accommodate the user's drain and pan material without deforming either and thereby creating a leak.

It is further desired that the tool arrangement be of sufficient size as to not readily fall into the drain especially after disengagement or reengagement of the tool arrangement with the retaining ring.

It is further desired that the arrangement be able to remove the retaining ring without deformity so that the retaining ring may be reused to seal the drain hole fixture to the drainpipe. It is preferred that the engagement or disengagement of the retaining ring be accomplished, without requiring great strength on the part of the user.

It is further desired that the arrangement allow disengagement of the retaining ring even though the drain fixture is adversely affected by a build up of sealant, corrosion or water or soap residue deposits.

It is further desired that the engagement not require strong, uneven pressure that would deform the drain or surrounding pan material upon which the drain fixture is mounted.

It is desired that a simple engagement of the insert tool fabricated according to the teaching of this invention be engageable with selected user's existing tools such as the lever of a socket wrench set with a latching or unlatching movement to engage and disengage the insert tool securely to the lever to prevent the separation of the tool arrangement.

It is desired that this engagement of a lever with the insert tool provide an arrangement whereby sufficient, evenly distributed torque to disengage the retaining ring without deformity to the retaining ring or drain fixture may be applied.

It is further desired that the insert tool be insertable into major manufacturer's retaining rings without requiring any special connector to be mounted to the insert tool or retaining ring.

### SUMMARY OF THE INVENTION

Accordingly, it is an object of the present invention to provide a quick assembly of a tool arrangement, engagement of the tool arrangement with the retaining ring, application of torque by the user and release of any seal of the retaining ring from the drain fixture without deformity to the insert tool or the retaining ring.

It is an object of the present invention to provide an improved tool arrangement that allows the user to remove the retaining ring, replace any internal seals or grommets and reinstall the retaining ring in a watertight configuration and thereafter not require any adjustment to the tension on the retaining ring even after application of hot water and years of use.

It is another object of the present invention to provide a method of engagement and disengagement of the retaining ring from the drain fixture by application of sufficient, evenly applied torque to overcome the seal but not deform the parts.

It is yet another object of the present invention to provide a disengagement and engagement arrangement which is not adversely affected by a build up of corrosion or deposits and be used without strong pressure which may strip the threads or deform the surrounding material. The insert tool should incorporate an arrangement for connection to other tools whereby a mechanical advantage to remove and reinstall the retaining ring with pressure in an acceptable range.

It is yet another object of the present invention to be easily mountable into any “standard retaining ring” and accept standard tools as which may be currently owned by the user as levers to provide torque to the tool arrangement to remove the retaining ring from the drain fixture.

The above and other objects of the present invention are achieved, according to a preferred embodiment thereof, by providing an improved insert tool mountable to engage to internal channels of the retaining ring without disengagement of the insert tool from the channels and loss of the insert tool down the drain. Upon release of the retaining ring from the drain fixture, the retaining ring may be re-positioned for reengagement with the drain fixture.

In the preferred embodiment, the insert tool is fabricated of a central body with peripheral extending spokes to span the drain, said spokes positioned to be engageable within the internal channels of the retaining ring mounted to one end of the drain pipe fixture. The central body including an opening engageable by a lever to assemble a tool arrangement whereby said tool arrangement may be used with increased mechanical advantage to apply torque to the retaining ring for removal of the retaining ring even under the condition of the retaining ring being sealed to the drain pipe fixture by corrosion, deposits or calking without requiring any special adaptors or extra ordinary strength on the part of the user.

### BRIEF DESCRIPTION OF THE DRAWINGS

The above and other embodiments of the present invention may be more fully understood from the following detailed description, taken together with the accompanying drawings, wherein similar reference characters refer to similar elements throughout, and in which:

FIG. 1 is a perspective view of the insert tool embodying the present invention;

FIG. 1a is a perspective view of the drain manufacturer's supplied throwaway tool;

FIG. 2 is a cross-sectional view of the insert tool depicted in FIG. 1 taking along line 2-2 thereof;

FIG. 3 is a top view of a shower drain fixture and the insert tool illustrated in FIG. 1 positioned therein; and,

FIG. 4 is a view of the shower drain fixture shown in FIG. 3 taken along line 4-4 thereof.

### DESCRIPTION OF A PREFERRED EMBODIMENT

Drains for showers or sinks provide an egress for water to be conveyed from the shower or sink fixture to a sewer, and include a sealing mechanism through an opening in the bottom of the shower pan or sink for permitting the opening to be coupled and sealed to a drainpipe. The seal conventionally comprises a drain fitting clamped to the pan or sink opening by an exterior locking nut and sealing a washer/gasket arrangement between one end of the drain fitting and the pan. The drainpipe is inserted into and within the other end of the drain fitting. A grommet is placed about the end of the drainpipe and pressure is applied to the grommet by tightening an internal nut to seal the connection between the drainpipe and the interior of the drain fixture. The interior nut is threaded into a mating thread on the interior of the drain fixture in contact with the grommet. Threading of the interior nut into the drain fitting enables the interior nut to press against the grommet and cause the grommet to be squeezed against the drain pipe and the drain fitting, thereby assuring a tight, water sealing connection between the drain pipe and the drain fitting.

The interior nut is provided with a plurality of channels placed about its interior circumferential edge. Upon engagement of the interior nut with the pipe fixtures these channels enable a user to place the insert tool that is the subject of this invention within the channels of the interior nut for the final tightening of the interior nut against the grommet. Removal of the interior nut is conducted in a similar manner. Over the period of use of the drain fixture by minerals and other matter washed into the drainpipe with the drain water. Such cementing resists the removal of the interior nut and creates a maintenance problem.

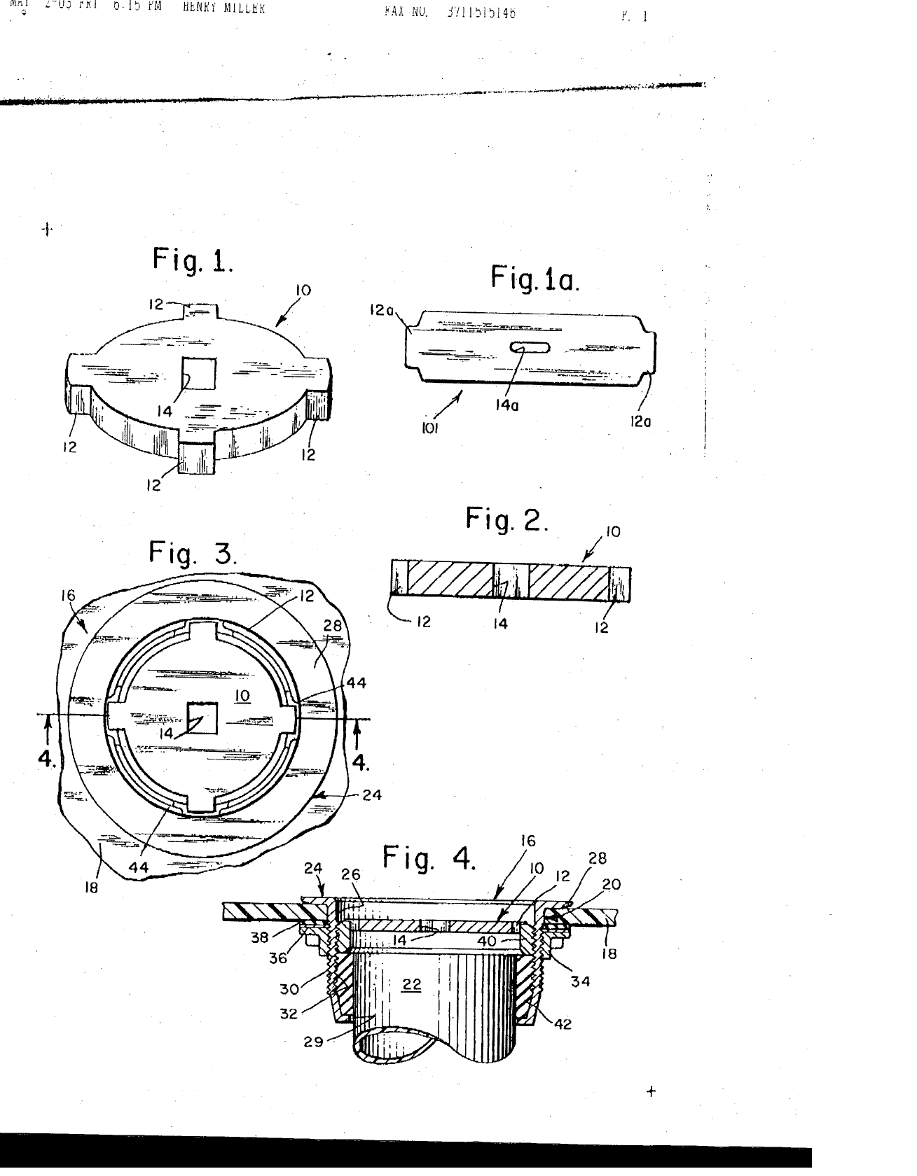

Referring now to the drawing, FIG. 1 shows the insert tool, generally designated 10, fabricated according to the invention of a central body 11, generally circularly in shape and fabricated of stock of sufficient thickness to be engageable by the handle of a common socket wrench set to be used as a lever. In the preferred embodiment, the insert tool 10 is fabricated of at least ¼ inch thick aluminum sheet stock. The insert tool 10 is fabricated with a preselected number of spokes 12 positioned on the outside circumferential edge of the central body 11. The preferred number of spokes 12 is at least two but four or even eight spokes 12 may be used in some configurations. First wall 14 is positioned generally at the hub of the central body 11 to provide a non-circular opening for the insertion of a lever. The user-supplied lever may be the handle of a socket wrench set. The shaft extending from the socket wrench handle upon which sockets are mounted may be inserted into the first wall 14 and may contain a detainer means to secure the shaft to the insert tool 10 to prevent inadvertent separation of the insert tool from the lever and dropping of the insert tool 10 into the drain. In the preferred embodiment, the overall dimensions of the central body 11 and extended spokes 12 is selected to prevent the insert tool 10 from passing through the drain fixture and into the drainpipe.

Not shown in the drawing is the fabrication of a plurality of first walls 14 positioned generally on opposite sides of the hub of the central body 11 and of a size to accommodate a multi-pronged tool such as the open jaws of adjustable pliers that may be used to provide a lever to apply torque to the central body 11 after insertion of the jaws of the pliers into said first walls 14. A configuration of three first walls 14 may be used to provide a more even torque without slippage between the lever and the insert tool 10. This configuration may be useful to perform extended maintenance that may be required to reseal multiple drains should a large building be subjected to severe weather or earthquake that shifted the drainpipes.

The overall function of the invention herein is best understood from FIGS. 3 and 4. The drain fixture, generally designated 16, is disposed to be secured within a hole formed in the bottom of a shower or sink as represented by the shower pan floor 18. The drain fixture 16 includes a fitting generally designated 24 having a cylindrical portion 26, an outwardly extending peripheral lip 28 at the top end of the cylindrical portion 26 and an inwardly extending peripheral lip 29 at the bottom end of the cylindrical portion 29. The cylindrical portion 26 is sized to permit the drain fitting to be inserted through the opening in the pan floor 18 formed by second wall 20 allowing lip 28 to rest atop the pan floor 18.

The cylindrical portion 26 of the fitting 24 is provided with an external thread 30 and an internal thread 32.

A gasket 38 and washer 36 is applied to the top of an external nut 34 that is threaded onto external thread 30 whereby tightening of the external nut 34 presses the gasket 36 and washer against to the underside of the pan floor 18 thereby securing the pan floor 18 between the outwardly extending peripheral lip 28 and the external nut 34, the gasket 38 and washer 36 providing a waterproof seal there between.

An internal nut 40 is engageable with the internal thread 32.

A grommet 42 of sealing material such as rubber or the like is fabricated to be placed within the lower part of the cylindrical portion 26 and held in place by the inwardly extending lip 29 thereby positioned to be in contact with the inside of the cylindrical portion 26 and the outside wall of a drain pipe 22. Tightening of the internal nut 40 into the drain fitting 24 presses the grommet 42 firmly against the cylindrical portion 26 and the drainpipe 22 to affect a waterproof seal there between.

Internal nut 40 is fabricated with a plurality of channels 44 formed in its internal circumferential edge at preselected intervals whereby the spokes 12 attached to the central body 11 of the insert tool are engageable with at least two spaced apart channels 44 upon the insertion of the insert tool 10 within the internal nut 40. Thereafter, a lever may be inserted into first walls 14 and the arrangement of the insert tool 10 and lever may be used to apply torque under a mechanical advantage to the internal nut 40 in order to tighten the internal nut 40 into the cylindrical wall 26. The snugness of the internal nut 40 into the cylindrical wall 26 should be sufficient to deform the grommet 42 and provide a waterproof connection between the cylindrical portion 26 and the drain 22 without deforming the internal nut 40 or the cylindrical portion 26 there after said insert 10 may be disengaged from said internal nut 40 thereby providing a clear drain path.

To remove the internal nut 40 from the cylindrical portion 26, the insert 10 is positioned to engage the spokes 12 with the channels 44, a lever is engaged with first wall 14 and torque sufficient to unscrew the internal nut 40 is applied.

In the prior art, the user may have had extreme difficulty to release the internal nut 40 from the cylindrical portion 26. The insert 10, fabricated according to the teaching of this invention upon assembly with a lever, allows the user to easily generate and apply sufficient, even torque to unscrew the internal nut 40 even if deposits, calking or corrosion has partially sealed the internal nut 40 to the cylindrical portion 26 all without deforming the insert 10, the internal nut 40 or the cylindrical portion 26.

FIG. 1a illustrates the prior art of a throw away tool generally designated 101 provided by the drain fixture manufacturer of the instant set shower drain arrangement. The tool 101 is provided with wall 14a generally shaped to accept a screwdriver blade. The remote ends of the tool 101 terminate with spokes 12a shaped to engage opposing channels 44 of the internal nut 40 of the manufacturer's product. Because the tool 101 is provided merely as a convenience by the manufacturer and intended to be disposable, the tool 101 is generally stamped from thin sheet stock that lacks strength to withstand the intense torque sometimes required to disengage the internal nut 40 from the cylindrical portion 26. Further, the shape of wall 14a to accommodate a screwdriver place is insufficient to allow the user to insert an adequate lever into wall 14a and generate torque. Further, the lack of sufficient thickness of wall 14a to sufficiently engage the inserted lever allows the tool 101 to easily become dislodged from the lever and drop down the drain 22. Finally, the application of torque by only two opposing channels of the internal nut 40 may be inadequate to provide the even torque required to remove or tighten the internal nut 40 without deforming the drain fixture 24 or the internal nut 40.

In the preferred embodiment, four spokes 12 are mounted on the central body 11 to provide evenly applied torque to the internal nut 40.

For multiple drain installation or maintenance in a large building, the insert tool may be fabricated with more than four spikes 12, placement of first walls 14 in a spaced apart configuration and a lever configured to engage said first walls 14 for ease of use.

Since certain change may be made in the above apparatus without departing from the scope of the invention herein involved, it is intended that all matter contained in the above description, as shown in the accompanying drawing, shall be interpreted in an illustrative, and not a limiting sense.

What is claimed is:

1. A quick assembly and detachment of a tool arrangement, engageable with channels formed on the inside peripheral surface of an internal nut of a drain fixture to apply torque to said internal nut for installation and removal of the internal nut of a drain fixture without deforming said internal nut or drain fixture mounted by one end of said drain fixture within an opening of a shower pan floor or sink drain the other end of said drain fixture, the mounding of said drain fixture within an opening of said shower pan floor by means of an external nut and gasket/washer arrangement to provide a waterproof seal and insertion of the other end of the drain fixture having a grommet therein on a drainpipe, said grommet disposed to be in contact with said internal nut, the removal of said internal nut allowing maintenance of said drain fixture including the removal and replacement of said internal grommet mounted within said drain fixture whereby tightening of said internal nut compresses said grommet between the drain fixture and the drain pipe thereby establishing a water tight seal for egress of water from the shower or sink through said drain fixture into said drainpipe and comprising, in combination:
an insert tool having a generally circular shaped central body and a plurality of spokes extending outwardly from the outside circumferential edge of said central body, said spokes spaced apart to engage at least two of said channels formed in said internal nut;
a first wall forming a non-circularly opening generally positioned at the hub of said central body;
upon the condition of the insert tool spokes engaged within said channels of said internal ring, a user supplied lever is inserted into said first wall and the insert tool and lever tool arrangement is used to evenly apply torque to said internal nut to remove or tighten said internal nut within said drain fixture.

2. The tool arrangement defined in claim 1 wherein said insert tool is fabricated of stock a sufficient thickness to engage said user supplied lever.

3. The tool arrangement defined in claim 1 further comprising a plurality of said first walls forming a plurality of non-circular openings not positioned at the hub of said central body whereby said openings may accommodate said user tools as levers.

4. The tool arrangement defined in claim 1 wherein the mounting of said insert tool into said internal nut followed by the insertion of said user supplied lever into first walls completes the tool arrangement that may be used to apply an evenly distributed torque to loosen or tighten said internal nut.

5. The tool arrangement defined in claim 1 wherein said central body and circumferential spoke configuration is selected to conform to most designs of internal nut designs without requiring special adaptive brackets.

6. The tool arrangement defined in claim 5 further comprising a preselected configuration of a plurality of said first wall spaced apart from the hub of said central body to accommodate said user supplied lever whereby said tool arrangement may be used for multiple drain installations or maintenance of existing multiple drains.
